(19) United States
(12) Patent Application Publication
(10) Pub. No.: US 2007/0097017 A1
(43) Pub. Date: May 3, 2007

(54) Generating single-color sub-frames for projection

(76) Inventors: Simon Widdowson, Dublin, CA (US); Nelson Liang An Chang, San Jose, CA (US); Niranjan Damera-Venkata, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/265,241

(22) Filed: Nov. 2, 2005

(51) Int. Cl. G09G 5/00

(52) U.S. Cl. 345/1.3

(57) ABSTRACT

A method of displaying images with a display system. The method includes receiving image data for the images. A plurality of multiple-color frames corresponding to the image data are generated. A first single-color frame is generated based on the plurality of multiple-color frames. The first single-color frame is processed, thereby generating a first processed single-color sub-frame. A first plurality of single-color sub-frames are generated based on the first processed single-color sub-frame. The first plurality of single-color sub-frames are projected onto a target surface with a first projector.

### CROSS-REFERENCE TO RELATED APPLICATIONS

This application is related to U.S. patent application Ser. No. 11/080,223, filed Mar. 15, 2005, Attorney Docket No. 200500154-1, entitled “PROJECTION OF OVERLAPPING SINGLE-COLOR SUB-FRAMES ONTO A SURFACE”, and U.S. patent application Ser. No. 11/080,583, filed Mar. 15, 2005, Attorney Docket No. 200407867-1, entitled “PROJECTION OF OVERLAPPING SUB-FRAMES ONTO A SURFACE”, which are both hereby incorporated by reference herein.

### BACKGROUND

Two types of projection display systems are digital light processor (DLP) systems, and liquid crystal display (LCD) systems. It is desirable in some projection applications to provide a high lumen level output, but it is very costly to provide such output levels in existing DLP and LCD projection systems. Three choices exist for applications where high lumen levels are desired: (1) high-output projectors; (2) tiled, low-output projectors; and (3) superimposed, low-output projectors.

When information requirements are modest, a single high-output projector is typically employed. This approach dominates digital cinema today, and the images typically have a nice appearance. High-output projectors have the lowest lumen value (i.e., lumens per dollar). The lumen value of high output projectors is less than half of that found in low-end projectors. If the high output projector fails, the screen goes black. Also, parts and service are available for high output projectors only via a specialized niche market.

Tiled projection can deliver very high resolution, but it is difficult to hide the seams separating tiles, and output is often reduced to produce uniform tiles. Tiled projection can deliver the most pixels of information. For applications where large pixel counts are desired, such as command and control, tiled projection is a common choice. Registration, color, and brightness must be carefully controlled in tiled projection. Matching color and brightness is accomplished by attenuating output, which costs lumens. If a single projector fails in a tiled projection system, the composite image is ruined.

Superimposed projection provides excellent fault tolerance and full brightness utilization, but resolution is typically compromised. Algorithms that seek to enhance resolution by offsetting multiple projection elements have been previously proposed. These methods assume simple shift offsets between projectors, use frequency domain analyses, and rely on heuristic methods to compute component sub-frames. The proposed systems do not generate optimal sub-frames in real-time, and do not take into account arbitrary relative geometric distortion between the component projectors, and do not project single-color sub-frames.

Multi-projector systems have multiple benefits in a wide range of display applications, but at the moment the system requirements are relatively steep. Each projector typically uses a dedicated graphics processing unit (GPU), and significant memory bandwidth in order to supply the content fast enough (e.g., in real-time). In addition, the overall efficiency of processing sub-frames is typically low.

### SUMMARY

One form of the present invention provides a method of displaying images with a display system. The method includes receiving image data for the images. The method includes generating a plurality of multiple-color frames corresponding to the image data. The method includes generating a first single-color frame based on the plurality of multiple-color frames. The method includes processing the first single-color frame, thereby generating a first processed single-color sub-frame. The method includes generating a first plurality of single-color sub-frames based on the first processed single-color sub-frame. The method includes projecting the first plurality of single-color sub-frames onto a target surface with a first projector.

### BRIEF DESCRIPTION OF THE DRAWINGS

FIG. 1 is a block diagram illustrating an image display system according to one embodiment of the present invention.

FIGS. 2A-2C are schematic diagrams illustrating the projection of two sub-frames according to one embodiment of the present invention.

FIG. 3 is a diagram illustrating a model of an image formation process according to one embodiment of the present invention.

FIG. 4 is a diagram illustrating a method for adjusting the position of displayed sub-frames on the target surface according to one embodiment of the present invention.

FIG. 5 is a diagram illustrating a method for processing image frames for a single, color-dedicated projector in an image display system according to one embodiment of the present invention.

FIG. 6 is a diagram illustrating a method for processing image frames for a single, color-dedicated projector in an image display system according to another embodiment of the present invention.

FIG. 7 is a diagram illustrating a method for processing image frames for a plurality of color-dedicated projectors in an image display system according to one embodiment of the present invention.

FIG. 8 is a diagram illustrating a method for processing image frames for a plurality of color-dedicated projectors in an image display system according to another embodiment of the present invention.

FIG. 9 is a flow diagram illustrating a method of displaying images with a display system according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

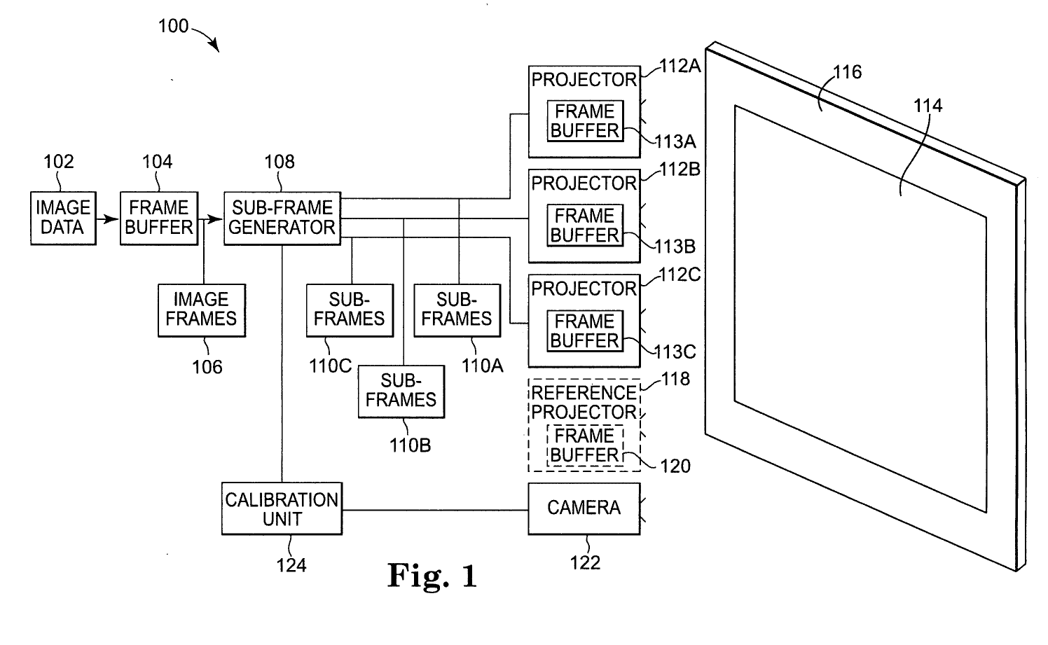

FIG. 1 is a block diagram illustrating an image display system 100 according to one embodiment of the present invention. Image display system 100 processes image data 102 and generates a corresponding displayed image 114. Displayed image 114 is defined to include any pictorial, graphical, or textural characters, symbols, illustrations, or other representations of information.

In one embodiment, image display system 100 includes image frame buffer 104, sub-frame generators 108, projectors 112A-112C (collectively referred to as projectors 112), camera 122, and calibration unit 124. Image frame buffer 104 receives and buffers image data 102 to create image frames 106. Sub-frame generator 108 processes image frames 106 to define corresponding image sub-frames 110A-110C (collectively referred to as sub-frames 110). In one embodiment, for each image frame 106, sub-frame generator 108 generates one sub-frame 110A for projector 112A, one sub-frame 110B for projector 112B, and one sub-frame 110C for projector 112C. The sub-frames 110A-110C are received by projectors 112A-112C, respectively, and stored in image frame buffers 113A-113C (collectively referred to as image frame buffers 113), respectively. Projectors 112A-112C project the sub-frames 110A-110C, respectively, onto target surface 116 to produce displayed image 114 for viewing by a user. Surface 116 can be planar or curved, or have any other shape. In one form of the invention, surface 116 is translucent, and display system 100 is configured as a rear projection system.

Image frame buffer 104 includes memory for storing image data 102 for one or more image frames 106. Thus, image frame buffer 104 constitutes a database of one or more image frames 106. Image frame buffers 113 also include memory for storing sub-frames 110. Examples of image frame buffers 104 and 113 include non-volatile memory (e.g., a hard disk drive or other persistent storage device) and may include volatile memory (e.g., random access memory (RAM)).

Sub-frame generator 108 receives and processes image frames 106 to define a plurality of image sub-frames 110. Sub-frame generator 108 generates sub-frames 110 based on image data in image frames 106. In one embodiment, sub-frame generator 108 generates image sub-frames 110 with a resolution that matches the resolution of projectors 112, which is less than the resolution of image frames 106 in one embodiment. Sub-frames 110 each include a plurality of columns and a plurality of rows of individual pixels representing a subset of an image frame 106.

In one embodiment, sub-frames 110 are each single-color sub-frames. In one form of the invention, sub-frames 110A are red sub-frames, sub-frames 110B are green sub-frames, and sub-frames 110C are blue sub-frames. In other embodiments, different colors may be used, and additional projectors 112 may be used to provide additional colors. In one form of the invention embodiment, each projector 112 projects single-color sub-frames 110 that are different in color than the color of the sub-frames 110 projected by the other projectors 112. In one embodiment, each projector 112 includes a color filter to generate the single-color for each sub-frame 110 projected by that projector 112.

Projectors 112 receive image sub-frames 110 from sub-frame generator 108 and, in one embodiment, simultaneously project the image sub-frames 110 onto target 116 at overlapping and spatially offset positions to produce displayed image 114. In one embodiment, display system 100 is configured to give the appearance to the human eye of high-resolution displayed images 114 by displaying overlapping and spatially shifted lower-resolution sub-frames 110 from multiple projectors 112. In one form of the invention, the projection of overlapping and spatially shifted sub-frames 110 gives the appearance of enhanced resolution (i.e., higher resolution than the sub-frames 110 themselves).

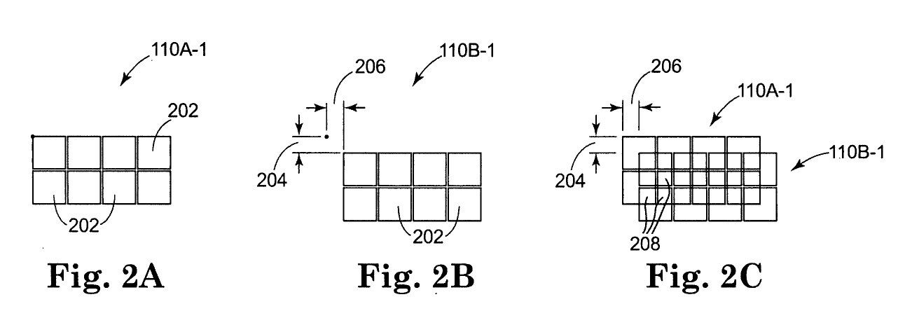

It will be understood by persons of ordinary skill in the art that the sub-frames 110 projected onto target 116 may have perspective distortions, and the pixels may not appear as perfect squares with no variation in the offsets and overlaps from pixel to pixel, such as that shown in FIGS. 2A-2C. Rather, in one form of the invention, the pixels of sub-frames 110 take the form of distorted quadrilaterals or some other shape, and the overlaps may vary as a function of position. Thus, terms such as “spatially shifted” and “spatially offset positions” as used herein are not limited to a particular pixel shape or fixed offsets and overlaps from pixel to pixel, but rather are intended to include any arbitrary pixel shape, and offsets and overlaps that may vary from pixel to pixel.

A problem of sub-frame generation, which is addressed by embodiments of the present invention, is to determine appropriate values for the sub-frames 110 so that the displayed image 114 produced by the projected sub-frames 110 is close in appearance to how the high-resolution image (e.g., image frame 106) from which the sub-frames 110 were derived would appear if displayed directly. Naïve overlapped projection of different colored sub-frames 110 by different projectors 112 can lead to significant color artifacts at the edges due to misregistration among the colors. A problem solved by one embodiment of the invention is to determine the single-color sub-frames 110 to be projected by each projector 112 so that the visibility of color artifacts is minimized.

It will be understood by a person of ordinary skill in the art that functions performed by sub-frame generator 108 may be implemented in hardware, software, firmware, or any combination thereof. In one embodiment, the implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

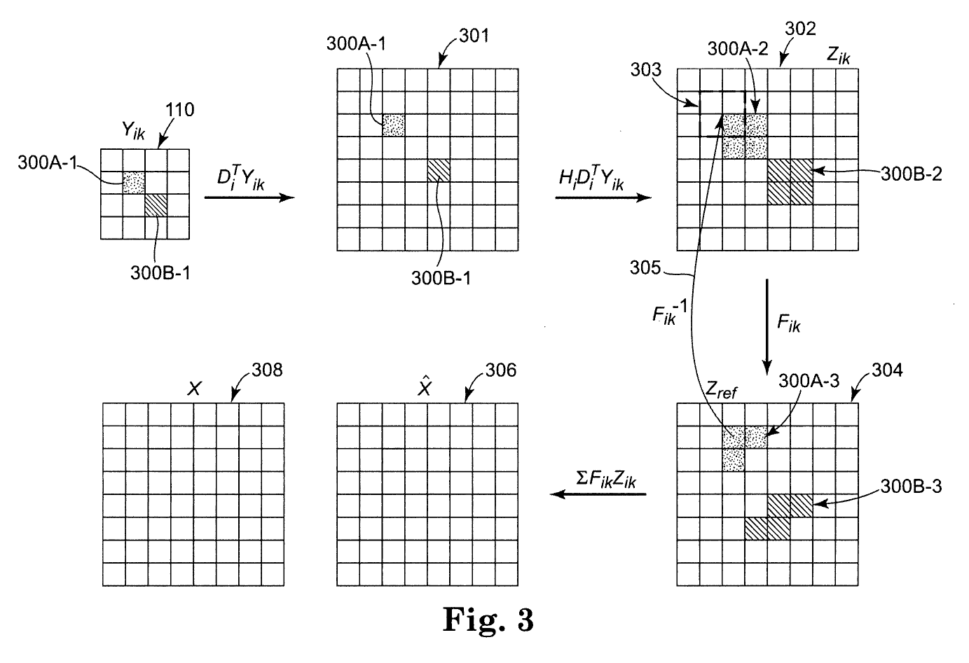

Also shown in FIG. 1 is reference projector 118 with an image frame buffer 120. Reference projector 118 is shown with hidden lines in FIG. 1 because, in one embodiment, projector 118 is not an actual projector, but rather is a hypothetical high-resolution reference projector that is used in an image formation model for generating optimal sub-frames 110, as described in further detail below with reference to FIGS. 2A-2C and 3. In one embodiment, the location of one of the actual projectors 112 is defined to be the location of the reference projector 118.

In one embodiment, display system 100 includes a camera 122 and a calibration unit 124, which are used in one form of the invention to automatically determine a geometric mapping between each projector 112 and the reference projector 118, as described in further detail below with reference to FIGS. 2A-2C and 3.

In one form of the invention, image display system 100 includes hardware, software, firmware, or a combination of these. In one embodiment, one or more components of image display system 100 are included in a computer, computer server, or other microprocessor-based system capable of performing a sequence of logic operations. In addition, processing can be distributed throughout the system with individual portions being implemented in separate system components, such as in a networked or multiple computing unit environment.

In one embodiment, display system 100 uses two projectors 112. FIGS. 2A-2C are schematic diagrams illustrating the projection of two sub-frames 110 according to one embodiment of the present invention. As illustrated in FIGS. 2A and 2B, sub-frame generator 108 defines two image sub-frames 110 for each of the image frames 106. More specifically, sub-frame generator 108 defines a first sub-frame 110A-1 and a second sub-frame 110B-1 for an image frame 106. As such, first sub-frame 110A-1 and second sub-frame 110B-1 each include a plurality of columns and a plurality of rows of individual pixels 202 of image data.

In one embodiment, as illustrated in FIG. 2B, when projected onto target 116, second sub-frame 110B-1 is offset from first sub-frame 110A-1 by a vertical distance 204 and a horizontal distance 206. As such, second sub-frame 110B-1 is spatially offset from first sub-frame 110A-1 by a predetermined distance. In one illustrative embodiment, vertical distance 204 and horizontal distance 206 are each approximately one-half of one pixel.

As illustrated in FIG. 2C, a first one of the projectors 112A projects first sub-frame 110A-1 in a first position and a second one of the projectors 112B simultaneously projects second sub-frame 110B-1 in a second position, spatially offset from the first position. More specifically, the display of second sub-frame 110B-1 is spatially shifted relative to the display of first sub-frame 110A-1 by vertical distance 204 and horizontal distance 206. As such, pixels of first sub-frame 110A-1 overlap pixels of second sub-frame 110B-1, thereby producing the appearance of higher resolution pixels 208. The overlapped sub-frames 110A-1 and 110B-1 also produce a brighter overall image 114 than either of the sub-frames 110 alone. In other embodiments, more than two projectors 112 are used in system 100, and more than two sub-frames 110 are defined for each image frame 106, which results in a further increase in the resolution, brightness, and color of the displayed image 114.

In one form of the invention, sub-frames 110 have a lower resolution than image frames 106. Thus, sub-frames 110 are also referred to herein as low-resolution images or sub-frames 110, and image frames 106 are also referred to herein as high-resolution images or frames 106. It will be understood by persons of ordinary skill in the art that the terms low resolution and high resolution are used herein in a comparative fashion, and are not limited to any particular minimum or maximum number of pixels.

In one form of the invention, display system 100 produces a superimposed projected output that takes advantage of natural pixel misregistration to provide a displayed image 114 with a higher resolution than the individual sub-frames 110. In one embodiment, image formation due to multiple overlapped projectors 112 is modeled using a signal processing model. Optimal sub-frames 110 for each of the component projectors 112 are estimated by sub-frame generator 108 based on the model, such that the resulting image predicted by the signal processing model is as close as possible to the desired high-resolution image to be projected. In one embodiment, the signal processing model is used to derive values for the sub-frames 110 that minimize visual color artifacts that can occur due to offset projection of single-color sub-frames 110.

In one embodiment, sub-frame generator 108 is configured to generate sub-frames 110 based on the maximization of a probability that, given a desired high resolution image, a simulated high-resolution image that is a function of the sub-frame values, is the same as the given, desired high-resolution image. If the generated sub-frames 110 are optimal, the simulated high-resolution image will be as close as possible to the desired high-resolution image.

One form of the present invention determines and generates single-color sub-frames 110 for each projector 112 that minimize color aliasing due to offset projection. This process may be thought of as inverse de-mosaicking. A de-mosaicking process seeks to synthesize a high-resolution, full color image free of color aliasing given color samples taken at relative offsets. One form of the present invention essentially performs the inverse of this process and determines the colorant values to be projected at relative offsets, given a full color high-resolution image 106. The generation of optimal sub-frames 110 based on a simulated high-resolution image and a desired high-resolution image is described in further detail below with reference to FIG. 3.

FIG. 3 is a diagram illustrating a model of an image formation process according to one embodiment of the present invention. The sub-frames 110 are represented in the model by Yᵢₖ, where “k” is an index for identifying individual sub-frames 110, and “i” is an index for identifying color planes. Two of the sixteen pixels of the sub-frame 110 shown in FIG. 3 are highlighted, and identified by reference numbers 300A-1 and 300B-1. The sub-frames 110 (Yᵢₖ) are represented on a hypothetical high-resolution grid by up-sampling (represented by Dᵢ^{T}) to create up-sampled image 301. The up-sampled image 301 is filtered with an interpolating filter (represented by Hᵢ) to create a high-resolution image 302 (Zᵢₖ) with “chunky pixels”. This relationship is expressed in the following Equation I:
Zᵢₖ=HᵢDᵢ^{T}Yᵢₖ Equation I

where:
k=index for identifying individual sub-frames 110;
i=index for identifying color planes;
Zᵢₖ=kth low-resolution sub-frame 110 in the ith color plane on a hypothetical high-resolution grid;
Hᵢ=Interpolating filter for low-resolution sub-frames 110 in the ith color plane;
Dᵢ^{T}=up-sampling matrix for sub-frames 110 in the ith color plane; and
Yᵢₖ=kth low-resolution sub-frame 110 in the ith color plane.

The low-resolution sub-frame pixel data (Yᵢₖ) is expanded with the up-sampling matrix (Dᵢ^{T}) so that the sub-frames 110 (Yᵢₖ) can be represented on a high-resolution grid. The interpolating filter (Hᵢ) fills in the missing pixel data produced by up-sampling. In the embodiment shown in FIG. 3, pixel 300A-1 from the original sub-frame 110 (Yᵢₖ) corresponds to four pixels 300A-2 in the high-resolution image 302 (Zᵢₖ), and pixel 300B-1 from the original sub-frame 110 (Yᵢₖ) corresponds to four pixels 300B-2 in the high-resolution image 302 (Zᵢₖ). The resulting image 302 (Zᵢₖ) in Equation I models the output of the projectors 112 if there was no relative distortion or noise in the projection process. Relative geometric distortion between the projected component sub-frames 110 results due to the different optical paths and locations of the component projectors 112. A geometric transformation is modeled with the operator, Fᵢₖ, which maps coordinates in the frame buffer 113 of a projector 112 to the frame buffer 120 of the reference projector 118 (FIG. 1) with sub-pixel accuracy, to generate a warped image 304 (Z_{ref}).

In one embodiment, Fᵢₖ is linear with respect to pixel intensities, but is non-linear with respect to the coordinate transformations. As shown in FIG. 3, the four pixels 300A-2 in image 302 are mapped to the three pixels 300A-3 in image 304, and the four pixels 300B-2 in image 302 are mapped to the four pixels 300B-3 in image 304.

In one embodiment, the geometric mapping (Fᵢₖ) is a floating-point mapping, but the destinations in the mapping are on an integer grid in image 304. Thus, it is possible for multiple pixels in image 302 to be mapped to the same pixel location in image 304, resulting in missing pixels in image 304. To avoid this situation, in one form of the present invention, during the forward mapping (Fᵢₖ), the inverse mapping (Fᵢₖ⁻¹) is also utilized as indicated at 305 in FIG. 3. Each destination pixel in image 304 is back projected (i.e., Fᵢₖ⁻¹) to find the corresponding location in image 302. For the embodiment shown in FIG. 3, the location in image 302 corresponding to the upper-left pixel of the pixels 300A-3 in image 304 is the location at the upper-left corner of the group of pixels 300A-2. In one form of the invention, the values for the pixels neighboring the identified location in image 302 are combined (e.g., averaged) to form the value for the corresponding pixel in image 304. Thus, for the example shown in FIG. 3, the value for the upper-left pixel in the group of pixels 300A-3 in image 304 is determined by averaging the values for the four pixels within the frame 303 in image 302.

In another embodiment of the invention, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 302 is mapped to a floating-point location in image 304, some of the image data for the pixel is essentially scattered to multiple pixels neighboring the floating point location in image 304. Thus, each pixel in image 304 may receive contributions from multiple pixels in image 302, and each pixel in image 304 is normalized based on the number of contributions it receives.

A superposition/summation of such warped images 304 from all of the component projectors 112 in a given color plane forms a hypothetical or simulated high-resolution image (X-hatᵢ) for that color plane in the reference projector frame buffer 120, as represented in the following Equation II:

$${\hat{X}}_{i} = {\sum }_{k} {F}_{ik} {Z}_{ik} \qquad Equation II$$

where:
k=index for identifying individual sub-frames 110;
i=index for identifying color planes;
X-hatᵢ=hypothetical or simulated high-resolution image for the ith color plane in the reference projector frame buffer 120;
Fᵢₖ=operator that maps the kth low-resolution sub-frame 110 in the ith color plane on a hypothetical high-resolution grid to the reference projector frame buffer 120; and
Zᵢₖ=kth low-resolution sub-frame 110 in the ith color plane on a hypothetical high-resolution grid, as defined in Equation I.

A hypothetical or simulated image 306 (X-hat) is represented by the following Equation III:
\hat{X}=[\hat{X}₁\hat{X}₂ . . . \hat{X}_{N}]^{T} Equation III

where:
X-hat=hypothetical or simulated high-resolution image in the reference projector frame buffer 120;
X-hat₁=hypothetical or simulated high-resolution image for the first color plane in the reference projector frame buffer 120, as defined in Equation II;
X-hat₂=hypothetical or simulated high-resolution image for the second color plane in the reference projector frame buffer 120, as defined in Equation II;
X-hat_{N}=hypothetical or simulated high-resolution image for the Nth color plane in the reference projector frame buffer 120, as defined in Equation II; and
N=number of color planes.

If the simulated high-resolution image 306 (X-hat) in the reference projector frame buffer 120 is identical to a given (desired) high-resolution image 308 (X), the system of component low-resolution projectors 112 would be equivalent to a hypothetical high-resolution projector placed at the same location as the reference projector 118 and sharing its optical path. In one embodiment, the desired high-resolution images 308 are the high-resolution image frames 106 (FIG. 1) received by sub-frame generator 108.

In one embodiment, the deviation of the simulated high-resolution image 306 (X-hat) from the desired high-resolution image 308 (X) is modeled as shown in the following Equation IV:
X=\hat{X}+η Equation IV

where:
X=desired high-resolution frame 308;
X-hat=hypothetical or simulated high-resolution frame 306 in the reference projector frame buffer 120; and
η=error or noise term.

As shown in Equation IV, the desired high-resolution image 308 (X) is defined as the simulated high-resolution image 306 (X-hat) plus η, which in one embodiment represents zero mean white Gaussian noise.

The solution for the optimal sub-frame data (Yᵢₖ*) for the sub-frames 110 is formulated as the optimization given in the following Equation V:

$${Y}_{ik}^{*} = {arg max}_{{Y}_{ik}} P ( \hat{X} \vert X ) \qquad Equation V$$

where:
k=index for identifying individual sub-frames 110;
i=index for identifying color planes;
Yᵢₖ*=optimum low-resolution sub-frame data for the kth sub-frame 110 in the ith color plane;
Yᵢₖ=kth low-resolution sub-frame 110 in the ith color plane;
X-hat=hypothetical or simulated high-resolution frame 306 in the reference projector frame buffer 120, as defined in Equation III;
X=desired high-resolution frame 308; and
P(X-hat|X)=probability of X-hat given X.

Thus, as indicated by Equation V, the goal of the optimization is to determine the sub-frame values (Yᵢₖ) that maximize the probability of X-hat given X. Given a desired high-resolution image 308 (X) to be projected, sub-frame generator 108 (FIG. 1) determines the component sub-frames 110 that maximize the probability that the simulated high-resolution image 306 (X-hat) is the same as or matches the “true” high-resolution image 308 (X).

Using Bayes rule, the probability P(X-hat|X) in Equation V can be written as shown in the following Equation VI:

$$P ( \hat{X} \vert X ) = \frac{P ( X \vert \hat{X} ) P ( \hat{X} )}{P ( X )} \qquad Equation VI$$

where:
X-hat=hypothetical or simulated high-resolution frame 306 in the reference projector frame buffer 120, as defined in Equation III;
X=desired high-resolution frame 308;
P(X-hat|X)=probability of X-hat given X;
P(X|X-hat)=probability of X given X-hat;
P(X-hat)=prior probability of X-hat; and
P(X)=prior probability of X.

The term P(X) in Equation VI is a known constant. If X-hat is given, then, referring to Equation IV, X depends only on the noise term, η, which is Gaussian. Thus, the term P(X|X-hat) in Equation VI will have a Gaussian form as shown in the following Equation VII:

$$P ( X \vert \hat{X} ) = \frac{1}{C} {ⅇ}^{- {\sum }_{i} \frac{( {‖ {X}_{i} - {\hat{X}}_{i} ‖}^{2} )}{2 {σ}_{i}^{2}}} \qquad Equation VII$$

where:
X-hat=hypothetical or simulated high-resolution frame 306 in the reference projector frame buffer 120, as defined in Equation III;
X=desired high-resolution frame 308;
P(X|X-hat)=probability of X given X-hat;
C=normalization constant;
i=index for identifying color planes;
Xᵢ=ith color plane of the desired high-resolution frame 308;
X-hatᵢ=hypothetical or simulated high-resolution image for the ith color plane in the reference projector frame buffer 120, as defined in Equation II; and
σᵢ=variance of the noise term, η, for the ith color plane.

To provide a solution that is robust to minor calibration errors and noise, a “smoothness” requirement is imposed on X-hat. In other words, it is assumed that good simulated images 306 have certain properties. For example, for most good color images, the luminance and chrominance derivatives are related by a certain value. In one embodiment, a smoothness requirement is imposed on the luminance and chrominance of the X-hat image based on a “Hel-Or” color prior model, which is a conventional color model known to those of ordinary skill in the art. The smoothness requirement according to one embodiment is expressed in terms of a desired probability distribution for X-hat given by the following Equation VIII:

$$P ( \hat{X} ) = \frac{1}{Z ( α , β )} {ⅇ}^{- \{ {α}^{2} ( {‖ ∇ {\hat{C}}_{1} ‖}^{2} + {‖ ∇ {\hat{C}}_{2} ‖}^{2} ) + {β}^{2} ( {‖ ∇ \hat{L} ‖}^{2} ) \}} \qquad Equation VIII$$

where:
P(X-hat)=prior probability of X-hat;
α and β=smoothing constants;
Z(α, β)=normalization function;
∇=gradient operator; and
C-hat₁=first chrominance channel of X-hat;
C-hat₂=second chrominance channel of X-hat; and
L-hat=luminance of X-hat.

In another embodiment of the invention, the smoothness requirement is based on a prior Laplacian model, and is expressed in terms of a probability distribution for X-hat given by the following Equation IX:

$$P ( \hat{X} ) = \frac{1}{Z ( α , β )} {ⅇ}^{- \{ α ( \vert ∇ {\hat{C}}_{1} \vert + \vert ∇ {\hat{C}}_{2} \vert ) + β ( \vert ∇ \hat{L} \vert ) \}} \qquad Equation IX$$

where:
P(X-hat)=prior probability of X-hat;
α and β=smoothing constants;
Z(α, β)=normalization function;
∇=gradient operator; and
C-hat₁=first chrominance channel of X-hat;
C-hat₂=second chrominance channel of X-hat; and
L-hat=luminance of X-hat.

The following discussion assumes that the probability distribution given in Equation VIII, rather than Equation IX, is being used. As will be understood by persons of ordinary skill in the art, a similar procedure would be followed if Equation IX were used. Inserting the probability distributions from Equations VII and VIII into Equation VI, and inserting the result into Equation V, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation V is transformed into a function minimization problem, as shown in the following Equation X:

$${Y}_{ik}^{*} = {arg min}_{{Y}_{ik}} {\sum }_{i = 1}^{N} {‖ {X}_{i} - {\hat{X}}_{i} ‖}^{2} + {α}^{2} \{ {‖ ∇ ( {\sum }_{i = 1}^{N} {T}_{{C}_{1} i} {\hat{X}}_{i} ) ‖}^{2} + {‖ ∇ ( {\sum }_{i = 1}^{N} {T}_{{C}_{2} i} {\hat{X}}_{i} ) ‖}^{2} \} + {β}^{2} {‖ ∇ ( {\sum }_{i = 1}^{N} {T}_{Li} {\hat{X}}_{i} ) ‖}^{2} \qquad Equation X$$

where:
k=index for identifying individual sub-frames 110;
i=index for identifying color planes;
Yᵢₖ*=optimum low-resolution sub-frame data for the kth sub-frame 110 in the ith color plane;
Yᵢₖ=kth low-resolution sub-frame 110 in the ith color plane;
N=number of color planes;
Xᵢ=ith color plane of the desired high-resolution frame 308;
X-hatᵢ=hypothetical or simulated high-resolution image for the ith color plane in the reference projector frame buffer 120, as defined in Equation II;
α and β=smoothing constants;
∇=gradient operator;
T_{C1i}=ith element in the second row in a color transformation matrix, T, for transforming the first chrominance channel of X-hat;
T_{C2i}=ith element in the third row in a color transformation matrix, T, for transforming the second chrominance channel of X-hat; and
T_{Li}=ith element in the first row in a color transformation matrix, T, for transforming the luminance of X-hat.

The function minimization problem given in Equation X is solved by substituting the definition of X-hatᵢ from Equation II into Equation X and taking the derivative with respect to Yᵢₖ, which results in an iterative algorithm given by the following Equation XI:

$${Y}_{ik}^{( n + 1 )} = {Y}_{ik}^{( n )} - Θ \{ {D}_{i} {F}_{ik}^{T} {H}_{i}^{T} [ \begin{matrix}( {\hat{X}}_{i}^{( n )} - {X}_{i} ) + \\ {α}^{2} {∇}^{2} ( \begin{matrix}{T}_{{C}_{1} i} {\sum }_{j = 1}^{N} {T}_{{C}_{1} j} {\hat{X}}_{j}^{( n )} + \\ {T}_{{C}_{2} i} {\sum }_{j = 1}^{N} {T}_{{C}_{2} j} {\hat{X}}_{j}^{( n )}\end{matrix} ) … + \\ {β}^{2} {∇}^{2} {T}_{Li} {\sum }_{j = 1}^{N} {T}_{Lj} {\hat{X}}_{j}^{( n )}\end{matrix} ] \} \qquad Equation XI$$

where:
k=index for identifying individual sub-frames 110;
i and j=indices for identifying color planes;
n=index for identifying iterations;
Yᵢₖ⁽ⁿ⁺¹⁾=kth low-resolution sub-frame 110 in the ith color plane for iteration number n+1;
Yᵢₖ⁽ⁿ⁺¹⁾=kth low-resolution sub-frame 110 in the ith color plane for iteration number n;
Θ=momentum parameter indicating the fraction of error to be incorporated at each iteration;
Dᵢ=down-sampling matrix for the ith color plane;
Hᵢ^{T}=Transpose of interpolating filter, Hᵢ, from Equation I (in the image domain, Hᵢ^{T} is a flipped version of Hᵢ);
Fᵢₖ^{T}=Transpose of operator, Fᵢₖ, from Equation II (in the image domain, Fᵢₖ^{T} is the inverse of the warp denoted by Fᵢₖ);
X-hatᵢ⁽ⁿ⁾=hypothetical or simulated high-resolution image for the ith color plane in the reference projector frame buffer 120, as defined in Equation II, for iteration number n;
Xᵢ=ith color plane of the desired high-resolution frame 308;
α and β=smoothing constants;
∇²=Laplacian operator;
T_{C1i}=ith element in the second row in a color transformation matrix, T, for transforming the first chrominance channel of X-hat;
T_{C2i}=ith element in the third row in a color transformation matrix, T, for transforming the second chrominance channel of X-hat;
T_{Li}=ith element in the first row in a color transformation matrix, T, for transforming the luminance of X-hat;
X-hatⱼ⁽ⁿ⁾=hypothetical or simulated high-resolution image for the jth color plane in the reference projector frame buffer 120, as defined in Equation II, for iteration number n;
T_{C1j}=jth element in the second row in a color transformation matrix, T, for transforming the first chrominance channel of X-hat;
T_{C2j}=jth element in the third row in a color transformation matrix, T, for transforming the second chrominance channel of X-hat;
T_{Lj}=jth element in the first row in a color transformation matrix, T, for transforming the luminance of X-hat; and
N=number of color planes.

Equation XI may be intuitively understood as an iterative process of computing an error in the reference projector 118 coordinate system and projecting it back onto the sub-frame data. In one embodiment, sub-frame generator 108 (FIG. 1) is configured to generate sub-frames 110 in real-time using Equation XI. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation XI can be implemented very efficiently with conventional image processing operations (e.g., transformations, down-sampling, and filtering). The iterative algorithm given by Equation XI converges rapidly in a few iterations and is very efficient in terms of memory and computation (e.g., a single iteration uses two rows in memory; and multiple iterations may also be rolled into a single step). The iterative algorithm given by Equation XI is suitable for real-time implementation, and may be used to generate optimal sub-frames 110 at video rates, for example.

To begin the iterative algorithm defined in Equation XI, an initial guess, Yᵢₖ⁽⁰⁾, for the sub-frames 110 is determined. In one embodiment, the initial guess for the sub-frames 110 is determined by texture mapping the desired high-resolution frame 308 onto the sub-frames 110. In one form of the invention, the initial guess is determined from the following Equation XII:
Yᵢₖ⁽⁰⁾=DᵢBᵢFᵢₖ^{T}Xᵢ Equation XII

where:
k=index for identifying individual sub-frames 110;
i=index for identifying color planes;
Yᵢₖ⁽⁰⁾=initial guess at the sub-frame data for the kth sub-frame 110 for the ith color plane;
Dᵢ=down-sampling matrix for the ith color plane;
Bᵢ=interpolation filter for the ith color plane;
Fᵢₖ^{T}=Transpose of operator, Fᵢₖ, from Equation II (in the image domain, Fᵢₖ^{T} is the inverse of the warp denoted by Fᵢₖ); and
Xᵢ=ith color plane of the desired high-resolution frame 308.

Thus, as indicated by Equation XII, the initial guess (Yᵢₖ⁽⁰⁾) is determined by performing a geometric transformation (Fᵢₖ^{T}) on the ith color plane of the desired high-resolution frame 308 (Xᵢ), and filtering (Bᵢ) and down-sampling (Dᵢ) the result. The particular combination of neighboring pixels from the desired high-resolution frame 308 that are used in generating the initial guess (Yᵢₖ⁽⁰⁾) will depend on the selected filter kernel for the interpolation filter (Bᵢ).

In another form of the invention, the initial guess, Yᵢₖ⁽⁰⁾, for the sub-frames 110 is determined from the following Equation XIII:
Yᵢₖ⁽⁰⁾=DᵢFᵢₖ^{T}Xᵢ Equation XIII

where:
k=index for identifying individual sub-frames 110;
i=index for identifying color planes;
Yᵢₖ⁽⁰⁾=initial guess at the sub-frame data for the kth sub-frame 110 for the ith color plane;
Dᵢ=down-sampling matrix for the ith color plane;
Fᵢₖ^{T}=Transpose of operator, Fᵢₖ, from Equation II (in the image domain, Fᵢₖ^{T} is the inverse of the warp denoted by Fᵢₖ); and
Xᵢ=ith color plane of the desired high-resolution frame 308.

Equation XIII is the same as Equation XII, except that the interpolation filter (Bₖ) is not used.

Several techniques are available to determine the geometric mapping (Fᵢₖ) between each projector 112 and the reference projector 118, including manually establishing the mappings, or using camera 122 and calibration unit 124 (FIG. 1) to automatically determine the mappings. Techniques for determining geometric mappings that are suitable for use in one form of the present invention are described in U.S. patent application Ser. No. 10/356,858, filed Feb. 3, 2003, entitled “MULTIFRAME CORRESPONDENCE ESTIMATION”, and U.S. patent application Ser. No. 11/068,195, filed Feb. 28, 2005, entitled “MULTI-PROJECTOR GEOMETRIC CALIBRATION”, both of which are hereby incorporated by reference herein.

In one embodiment, if camera 122 and calibration unit 124 are used, calibration unit 124 determines the geometric mappings between each projector 112 and the camera 122. These projector-to-camera mappings may be denoted by Tₖ, where k is an index for identifying projectors 112. Based on the projector-to-camera mappings (Tₖ), the geometric mappings (Fₖ) between each projector 112 and the reference projector 118 are determined by calibration unit 124, and provided to sub-frame generator 108. For example, in a display system 100 with two projectors 112A and 112B, assuming the first projector 112A is the reference projector 118, the geometric mapping of the second projector 112B to the first (reference) projector 112A can be determined as shown in the following Equation XIV:
F₂=T₂T₁⁻¹ Equation XIV

where:
F₂=operator that maps a low-resolution sub-frame 110 of the second projector 112B to the first (reference) projector 112A;
T₁=geometric mapping between the first projector 112A and the camera 122; and
T₂=geometric mapping between the second projector 112B and the camera 122.

In one embodiment, the geometric mappings (Fᵢₖ) are determined once by calibration unit 124, and provided to sub-frame generator 108. In another embodiment, calibration unit 124 continually determines (e.g., once per frame 106) the geometric mappings (Fᵢₖ), and continually provides updated values for the mappings to sub-frame generator 108.

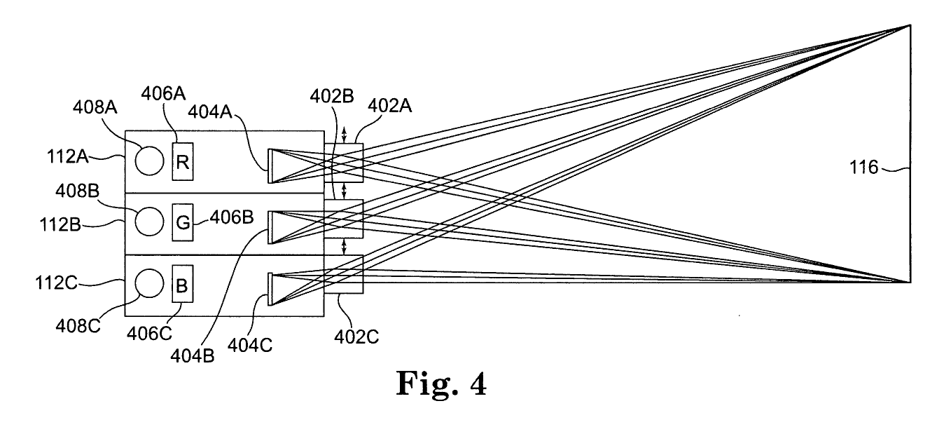

FIG. 4 is a diagram illustrating a projector configuration and a: method for adjusting the position of displayed sub-frames 110 on target surface 116 according to one embodiment of the present invention. In the embodiment illustrated in FIG. 4, projectors 112A-112C are stacked on top of each other, and project red, green, and blue sub-frames 110, respectively, onto target surface 116. Projector 112A includes projection lens 402A, light valves 404A, light filter 406A, and light source 408A. Projector 112B includes projection lens 402B, light valves 404B, light filter 406B, and light source 408B. Projector 112C includes projection lens 402C, light valves 404C, light filter 406C, and light source 408C. Light filters 406A-406C (collectively referred to as light filters 406) filter the light output by light sources 408A-408C (collectively referred to as light sources 408), respectively. The filtered light is provided to light valves 404A-404C, which direct the light to projection lenses 402A-402C, respectively. Projection lenses 402A-402C project the received light onto target surface 116. The light from each of the projectors 112 follows a different light path to the target surface 116.

In one embodiment, the position of displayed sub-frames 110 on target surface 116 for each projector 112A-112C is adjusted to a desired position by adjusting the transverse position of the projection lenses 402A-402C of the projectors 112A-112C relative to the light valves 404A-404C of the projectors 112A-112C (as indicated by the arrows in FIG. 4), which causes a translation of the sub-frames 110 on the target surface 116. In one form of the invention, the light source optics (not shown) of projectors 112 are also adjusted to maintain uniform screen illumination.

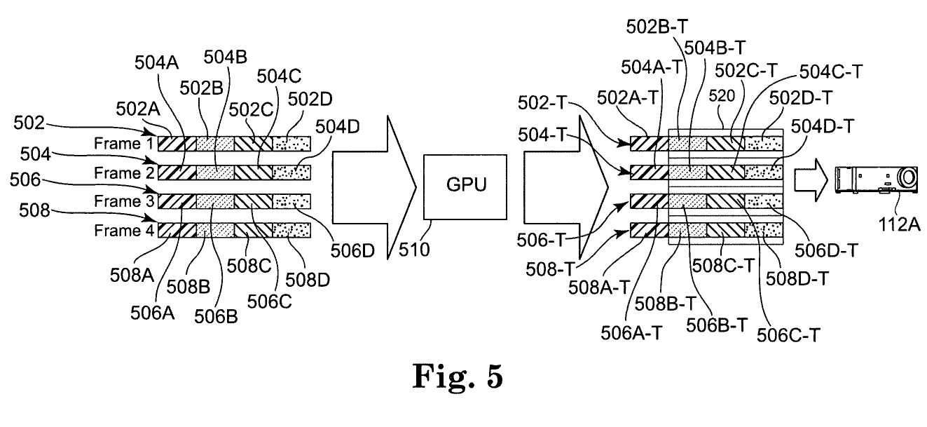

FIG. 5 is a diagram illustrating a method for processing image frames for a single, color-dedicated projector 112A in image display system 100 according to one embodiment of the present invention. Projector 112A is dedicated to projecting a single-color of light in one form of the invention, and is therefore referred to as a color-dedicated projector. In one embodiment, four sequential multiple-color (e.g., full-color) frames 502, 504, 506, and 508 are processed to provide input to color-dedicated projector 112A. In the illustrated embodiment, frames 502, 504, 506, and 508 are specific instances or examples of the image frames 106 shown in FIG. 1, and provide image data for four sequential time instances. Multiple-color frames 502, 504, 506, and 508 include color fields or color channels 502A-502D, 504A-504D, 506A-506D, and 508A-508D, respectively. In one embodiment, each multiple-color frame 502, 504, 506, and 508 is made up of 32 bits and each color field of these frames is made up of 8 bits. In one embodiment, color fields 502A, 504A, 506A, and 508A include red color data; color fields 502B, 504B, 506B, and 508B include blue color data; color fields 502C, 504C, 506C, and 508C include green color data; and color fields 502D, 504D, 506D, and 508D are alpha channels and include gray color data. In other embodiments, the color fields may include different color data.

FIG. 5 shows a diagrammatic representation of the image data for frames 502, 504, 506, and 508. In one form of the invention, the image data is organized in an RGBA (Red-Green-Blue-Alpha) per pixel configuration. In another embodiment, a different configuration or organization may be used.

In the embodiment shown in FIG. 5, processing of multiple-color 30 frames 502, 504, 506, and 508 is performed by graphical processing unit (GPU) 510. In another embodiment, processing of multiple-color frames 502, 504, 506, and 508 is performed by a field programmable gate array (FPGA) or an application specific integrated circuit (ASIC). In one embodiment, GPU 510 is included in sub-frame generator 108 (FIG. 1). GPU 510 receives multiple-color frames 502, 504, 506, and 508, and transforms the received multiple-color frames 502, 504, 506, and 508 one at a time to generate corresponding transformed multiple-color sub-frames 502-T, 504-T, 506-T, and 508-T, respectively. In the illustrated embodiment, sub-frames 502-T, 504-T, 506-T, and 508-T are specific instances or examples of the sub-frames 110 shown in FIG. 1.

Transformed multiple-color sub-frames 502-T, 504-T, 506-T, and 508-T include color fields 502A-T-502D-T, 504A-T-504D-T, 506A-T-506D-T, and 508A-T-508D-T, respectively. In one embodiment, each transformed multiple-color sub-frame 502-T, 504-T, 506-T, and 508-T is made up of 32 bits, and each color field of these sub-frames is made up of 8 bits. In one embodiment, color fields 502A-T, 504A-T, 506A-T, and 508A-T include red color data; color fields 502B-T, 504B-T, 506B-T, and 508B-T include blue color data; color fields 502C-T, 504C-T, 506C-T, and 508C-T include green color data, and color fields 502D-T, 504D-T, 506D-T, and 508D-T are alpha channels and include gray color data. In other embodiments, the color fields may include different color data.

In one embodiment, GPU 510 generates the transformed multiple-color sub-frames 502-T, 504-T, 506-T, and 508-T, based on the maximization of a probability that a simulated high resolution image is the same as a given, desired high-resolution image, as described above. In one form of the invention, GPU 510 generates the transformed multiple-color sub-frames 502-T, 504-T, 506-T, and 508-T, based on Equation XI above, and the processing operations performed by GPU 510 include down-sampling, filtering, and geometrically transforming received image data, as indicated in Equation XI and described above.

In one embodiment, multiple-color sub-frames 502-T, 504-T, 506-T, and 508-T are passed through a color filter 520 that removes all extra color fields (e.g., color fields 502B-T-502D-T, 504B-T-504D-T, 506B-T-506D-T, and 508B-T-508D-T) that are dissimilar to the color served by the color-dedicated projector 112A. The output of color filter 520 is four single-color sub-frames that are received by color-dedicated projector 112A and sequentially projected. A color filter 520 for discarding bits of the extra color fields may be implemented in hardware, software, firmware, or any combination thereof. The implementation may be via a microprocessor, programmable logic device, or a state machine. In one embodiment, color filter 520 is included in GPU 510.

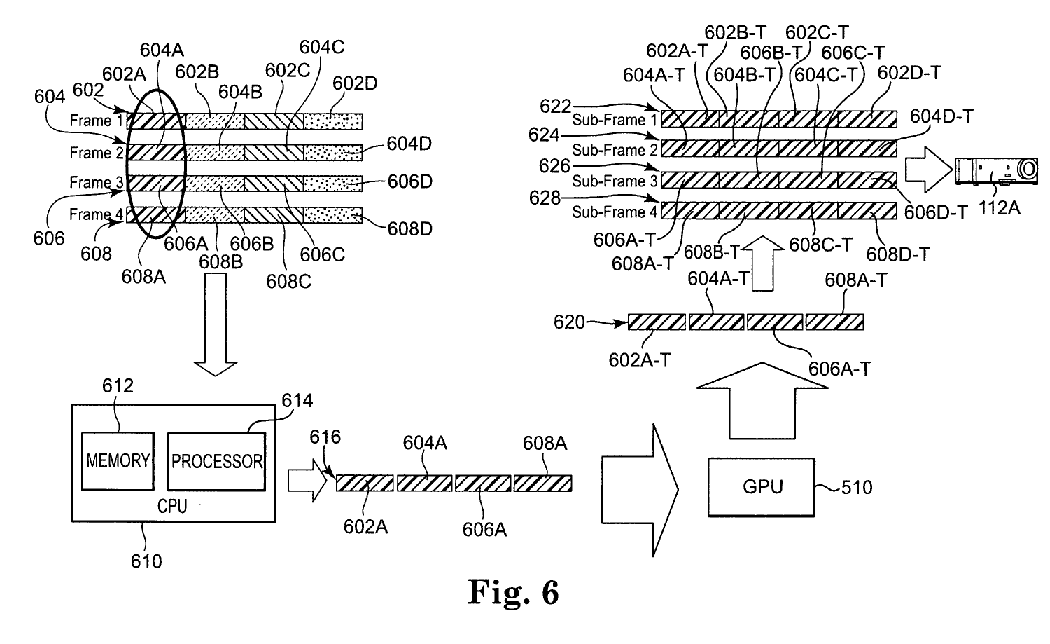

FIG. 6 is a diagram illustrating a method of processing image frames for a single, color-dedicated projector 112A in image display system 100 according to another embodiment of the present invention. The illustrated embodiment of the method involves processing four sequential multiple-color (e.g., full-color) frames 602, 604, 606, and 608 at a central processing unit CPU 610 followed by further processing at GPU 510 before projection by color-dedicated projector 112A. In the illustrated embodiment, frames 602, 604, 606, and 608 are specific instances or examples of the image frames 106 shown in FIG. 1, and provide image data for four sequential time instances. Multiple-color frames 602, 604, 606, and 608 include color fields 602A-602D, 604A-604D, 606A-606D, and 608A-608D, respectively. In one embodiment, each multiple-color frame 602, 604, 606, and 608 is made up of 32 bits and each color field of these frames is made up of 8 bits. In one embodiment, color fields 602A, 604A, 606A, and 608A include red color data; color fields 602B, 604B, 606B, and 608B include blue color data; color fields 602C, 604C, 606C, and 608C include green color data, and color fields 602D, 604D, 606D, and 608D are alpha channels and include gray color data. In other embodiments, the color fields may include different color data.

CPU 610 includes memory 612 and processor 614. In one embodiment, CPU 610 is integrated into GPU 510. In another embodiment, CPU 610 and GPU 510 are integrated into color-dedicated projector 112A. In an alternate form of the invention, the functionality of CPU 610 is performed by an ASIC, FPGA, or a digital signal processing (DSP) chip. Multiple-color frames 602, 604, 606, and 608 are stored in memory 612 before being processed by the processor 614. Processor 614 combines identically colored color fields 602A, 604A, 606A, and 608A from multiple-color frames 602, 604, 606, and 608 to form a single-color frame 616. Single-color frame 616 is transformed at GPU 510 to form a transformed single-color sub-frame 620, which includes color fields 602A-T, 604A-T, 606A-T, and 608A-T. In the illustrated embodiment, color fields 602A-T, 604A-T, 606A-T, and 608A-T include red color data.

In one embodiment, GPU 510 generates the transformed multiple-color sub-frame 620, based on the maximization of a probability that a simulated high-resolution image is the same as a given, desired high-resolution image, as described above. In one form of the invention, GPU 510 generates the transformed multiple-color sub-frame 620 based on Equation XI above, and the processing operations performed by GPU 510 include down-sampling, filtering, and geometrically transforming received image data, as indicated in Equation XI and described above.

In one embodiment, single-color sub-frame 620 is further processed by processor 614 to generate four single-color sub-frames 622, 624, 626, and 628. In the illustrated embodiment, sub-frames 622, 624, 626, and 628 are specific instances or examples of the sub-frames 110 shown in FIG. 1. In one embodiment, single-color sub-frame 622 includes color field 602A-T from sub-frame 620 and three additional color fields 602B-T, 602C-T, and 602D-T, which are replicated forms of 602A-T. Similarly, sub-frames 624, 626, and 628 include color fields 604A-T, 606A-T, and 608A-T, respectively, from sub-frame 620, followed by three replicated forms of color fields 604A-T, 606A-T, and 608A-T, respectively, which are represented in FIG. 6 by color fields 604B-T through 604D-T, 606B-T through 606D-T, and 608B-T through 606D-T, respectively. Thus, in the illustrated embodiment, sub-frames 622, 624, 626, and 628 each include four 8-bit fields of red color data. Single-color sub-frames 622, 624, 626 and 628 are received by color-dedicated projector 112A and sequentially projected.

The embodiment of the method of processing individual sub-frames shown in FIG. 6 is more efficient than the embodiment shown in FIG. 5. In the embodiment shown in FIG. 5, GPU 510 processes extra color fields that are later removed by filter 520. In other words, sub-frames 502-T, 504-T, 506-T, and 508-T contain only one color field each that is used by the color dedicated projector 112A. The three remaining color fields for each sub-frame 502-T, 504-T, 506-T, and 508-T are removed or discarded by filter 520 after being processed by GPU 510. The embodiment shown in FIG. 6 eliminates this processing of extra color fields having colors other than that served by color-dedicated projector 112A. The embodiment of the method shown in FIG. 6 provides a more efficient use of the processing power of GPU 510. Consequently, additional color fields having projector 112A as their destination can be processed at GPU 510. Processing of these additional color fields increases the speed at which sub-frames are generated and provided to projector 112A. In the embodiment shown in FIG. 6, GPU 510 simultaneously processes four sequential sub-frames of one color, instead of processing one sub-frame of four colors. Hence, there is a four-fold improvement in the processing speed at GPU 510.

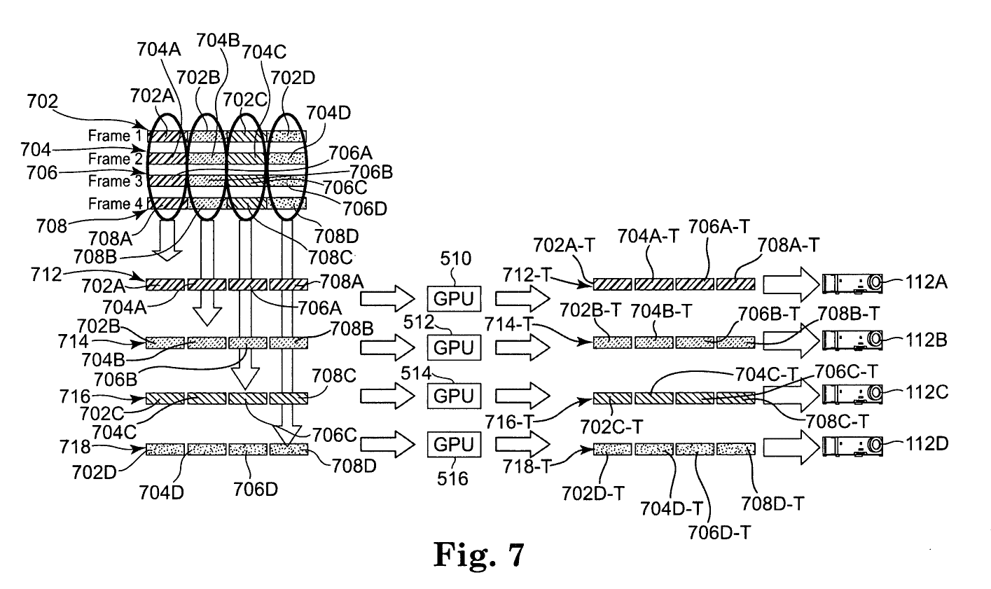

FIG. 7 is a diagram illustrating a method for processing image frames for a plurality of color-dedicated projectors 112A-112D in image display system 100 according to one embodiment of the present invention. The illustrated embodiment of the method involves processing four sequential multiple-color (e.g., full-color) frames 702, 704, 706, and 708 at central processing unit CPU 610 (FIG. 6) followed by further processing at GPUs 510, 512, 514, and 516, respectively, before projection by color-dedicated projectors 112A, 112B, 112C, and 112D. In the illustrated embodiment, frames 702, 704, 706, and 708 are specific instances or examples of the image frames 106 shown in FIG. 1, and provide image data for four sequential time instances. Multiple-color frames 702, 704, 706, and 708 include color fields 702A-702D, 704A-704D, 706A-706D, and 708A-708D, respectively. In one embodiment, each multiple-color frame 702, 704, 706, and 708 is made up of 32 bits and each color field of these frames is made up of 8 bits. In one embodiment, color fields 702A, 704A, 706A, and 708A include red color data; color fields 702B, 704B, 706B, and 708B include blue color data; color fields 702C, 704C, 706C, and 708C include green color data, and color fields 702D, 704D, 706D, and 708D are alpha channels and include gray color data. In other embodiments, the color fields may include different color data.

In one embodiment, multiple-color frames 702, 704, 706 and 708 are stored in memory 612 (FIG. 6) and are made available to processor 614 of CPU 610. In one embodiment, processor 614 separately combines color fields 702A through 708A, 702B through 708B, 702C through 708C, and 702D through 708D, and thereby forms corresponding single-color frames 712, 714, 716, and 718, respectively. Single-color frames 712, 714, 716, and 718 are transformed at GPUs 510, 512, 514, and 516, respectively, to form corresponding transformed single-color sub-frames 712-T, 714-T, 716-T, and 718-T, respectively. In the illustrated embodiment, sub-frames 712-T, 714-T, 716-T, and 718-T are specific instances or examples of the sub-frames 110 shown in FIG. 1. Transformed single-color sub-frames 712-T, 714-T, 716-T and 718-T include color fields 702A-T through 708A-T, 702B-T through 708B-T, 702C-T through 708C-T, and 702D-T through 708D-T, respectively. In one embodiment, color fields 702A-T, 704A-T, 706A-T, and 708A-T include red color data; color fields 702B-T, 704B-T, 706B-T, and 708B-T include blue color data; color fields 702C-T, 704C-T, 706C-T, and 708C-T include green color data, and color fields 702D-T, 704D-T, 706D-T, and 708D-T are alpha channels and include gray color data. In other embodiments, the color fields may include different color data.

In one embodiment, GPUs 510, 512, 514, and 516 generate the transformed multiple-color sub-frames 712-T, 714-T, 716-T, and 718-T, respectively, based on the maximization of a probability that a simulated high-resolution image is the same as a given, desired high-resolution image, as described above. In one form of the invention, GPUs 510, 512, 514, and 516 generate the transformed multiple-color sub-frames 712-T, 714-T, 716-T, and 718-T, respectively, based on Equation XI above, and the processing operations performed by GPUs 510, 512, 514, and 516 include down-sampling, filtering, and geometrically transforming received image data, as indicated in Equation XI and described above.

In one embodiment, each of the 8-bit color fields 702A-T through 708A-T, 702B-T through 708B-T, 702C-T through 708C-T, and 702D-T through 708D-T is converted into a corresponding 32-bit sub-frame by processor 614 (FIG. 6) by replicating the color fields as described above with respect to FIG. 6. In this manner, four sequential 32-bit single-color sub-frames are generated for each of the projectors 112A-112D. In one embodiment, projectors 112A-112D simultaneously project a first set of sub-frames corresponding to color fields 702A-T through 702D-T, respectively; then simultaneously project a second set of sub-frames corresponding to color fields 704A-T through 704D-T, respectively; then simultaneously project a third set of sub-frames corresponding to color fields 706A-T through 706D-T, respectively; then simultaneously project a fourth set of sub-frames corresponding to color fields 708A-T through 708D-T, respectively.

The embodiment of the method of processing individual sub-frames shown in FIG. 7 is more efficient than the embodiment shown in FIG. 5. The embodiment shown in FIG. 7 eliminates the processing of extra color fields having colors other than that served by the color-dedicated projectors 112A-112D, provides a more efficient use of the processing power of GPUs 510, 512, 514, and 516, and increases the speed at which sub-frames are generated and provided to projectors 112A-112D. In the embodiment shown in FIG. 7, each of the GPUs 510, 512, 514, and 516 simultaneously processes four sequential sub-frames of one color, instead of processing one sub-frame of four colors. Hence, there is a four-fold improvement in the processing speed at each of the GPUs 510, 512, 514, and 516.

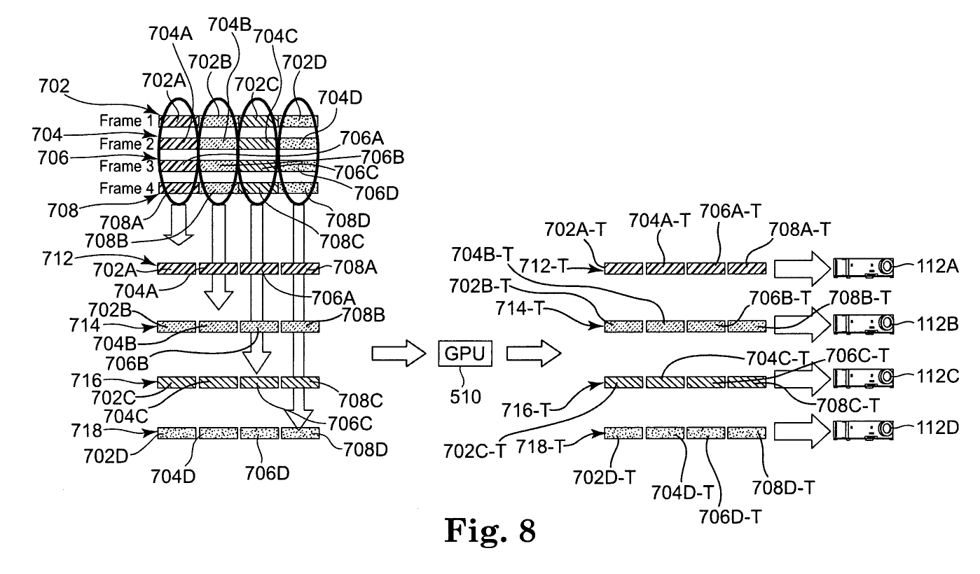

FIG. 8 is a diagram illustrating a method for processing image frames for a plurality of color-dedicated projectors 112A-112D in image display system 100 according to another embodiment of the present invention. The embodiment shown in FIG. 8 is the same as that shown in FIG. 7, with the exception that, rather than having a dedicated GPU for each projector 112 as shown in FIG. 7, a single GPU 510 serves multiple projectors 112A-112D in the embodiment shown in FIG. 8. In the embodiment shown in FIG. 7, each of the GPUs 510, 512, 514, and 516, applies a different geometric transformation than that applied by the other GPUs in the system 100. In the embodiment shown in FIG. 8, the GPU 510 serves four different projectors 112A-112D, and is configured to perform a geometric transformation that is appropriate for each of the four different projectors 112A-112D (i.e., four different geometric transformations).

In one embodiment, GPUs 510, 512, 514, and 516 are each configured to apply geometric transformations in 32-bit quantities at a time, and projectors 112A-112D are each configured to display 8-bits of any one color at a time. Thus, in one form of the invention, when four GPUs 510, 512, 514, and 516 are used to serve four projectors 112A-112D as shown in FIG. 7, the four GPUs 510, 512, 514, and 516 are able to simultaneously process and geometrically transform the four 32-bit frames 712, 714, 716, and 718, and thereby produce sub-frame data for 16 sub-frames at a time (i.e., 4 sub-frames for each projector 112A-112D to be projected at 4 sequential time instances by each projector).

When a single GPU 510 serves the four projectors 112A-112D as shown in FIG. 8, in one form of the invention, the GPU 510 is configured to sequentially process and geometrically transform the four 32-bit frames 712, 714, 716, and 718, and thereby produce sub-frame data for 4 sub-frames at a time (i.e., 4 sub-frames for any one of the projectors 112A-112D to be projected at 4 sequential time instances by that projector). Thus, in the embodiment shown in FIG. 8, a cost reduction is achieved by reducing the number of GPUs, and GPU 510 is able to serve 4 projectors 112A-112D at the same rate as a single projector 112A is served in the embodiment shown in FIG. 5.

In one form of the invention, since the first projector 112A in the embodiment shown in FIG. 8 does not project its sub-frame from a given set (e.g., the first set, second set, third set, or fourth set) until the fourth projector 112D also receives its sub-frame from that set (e.g., four sub-frames later), the generated sub-frames are stored or cached prior to being projected. In one embodiment, the generated sub-frames are stored in memory 612 (FIG. 6). In another embodiment, the generated sub-frames are stored in frame buffers 113 (FIG. 1). The amount of cached data may be minimized by staggering the sub-frames. For example, the sub-frame could be staggered such that the first projector 112A receives sub-frames 1-4, the second projector 112B receives sub-frames 2-5, the third projector 112C receives sub-frames 3-6, and the fourth projector 112D receives sub-frames 4-7.

The embodiment of the method of processing individual frames shown in FIG. 8 and described above enhances the processing efficiency of GPU 510, and thereby provides the ability for multiple color-dedicated projectors 112A -112D to be served by a single GPU 510. As a result, the embodiment of the method shown in FIG. 8 provides a considerable reduction in cost compared to a system that uses a different GPU for each projector.

In the embodiments shown in FIGS. 6-8, and described above, the GPUs are each configured to apply geometric transformations in 32-bit quantities (four 8-bit bytes) at a time, and are each configured to produce sub-frame data for 4 sub-frames at a time. In another form of the invention, the GPUs are each configured to apply geometric transformations in more or less than 32-bit quantities at a time (e.g., 8 bits at a time, or 64 bits at a time), and are each configured to produce sub-frame data for more or less than 4 sub-frames at a time.

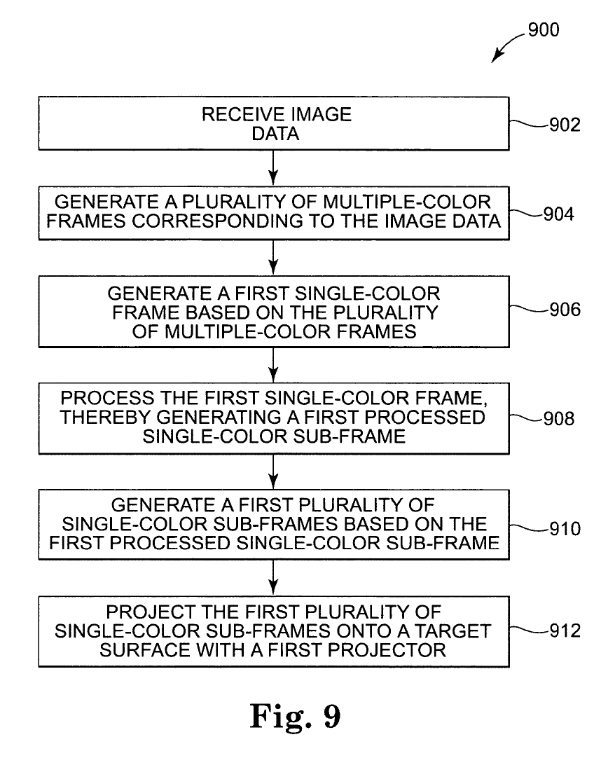

FIG. 9 is a flow diagram illustrating a method 900 of displaying images with display system 100 (FIG. 1) according to one embodiment of the present invention. At 902, frame buffer 104 receives image data 102 for the images. At 904, frame buffer 104 generates a plurality of multiple-color frames (e.g., frames 602-608 shown in FIG. 6) corresponding to the image data 102. At 906, sub-frame generator 108 generates a first single-color frame (e.g., frame 616 shown in FIG. 6) based on the plurality of multiple-color frames. In one embodiment, a CPU (e.g., CPU 610 shown in FIG. 6) within sub-frame generator 108 generates the first single-color frame at 906 by combining color fields from the plurality of multiple-color frames as described above with respect to FIG. 6.

At 908, sub-frame generator 108 processes the first single-color frame, thereby generating a first processed single-color sub-frame (e.g., sub-frame 620 shown in FIG. 6). In one embodiment, the first single-color frame is processed at 908 by a GPU (e.g., GPU 5 10 shown in FIG. 6) within sub-frame generator 108. In one embodiment, the first processed single-color sub-frame is generated at 908 according to the techniques shown in FIG. 3 and described above, where an initial guess for the sub-frame is determined from the high resolution image data 102 (see, e.g., Equations XII and XIII and corresponding description). The first processed single-color sub-frame is then generated from the initial guesses using an iterative process (see, e.g., Equation XI and corresponding description) that is based on the model shown in FIG. 3 and described above.

At 910, sub-frame generator 108 generates a first plurality of single-color sub-frames (e.g., sub-frames 622-628 shown in FIG. 6) based on the first processed single-color sub-frame. In one embodiment, sub-frame generator 108 generates the first plurality of single-color sub-frames at 910 as described above with respect to FIG. 6. At 912, a first projector 112A projects the first plurality of single-color sub-frames onto target surface 116.

One form of the present invention provides an image display system 100 with multiple overlapped-low-resolution projectors 112 coupled with an efficient real-time (e.g., video rates) image-processing algorithm for generating sub-frames 110. In one embodiment, multiple low-resolution; low-cost projectors 112 are used to produce high resolution images 114 at high lumen levels, but at lower cost than existing high-resolution projection systems, such as a single, high-resolution, high-output projector. One form of the present invention provides a scalable image display system 100 that can provide virtually any desired resolution, brightness, and color, by adding any desired number of component projectors 112 to the system 100.

In some existing display systems, multiple low-resolution images are displayed with temporal and sub-pixel spatial offsets to enhance resolution. There are some important differences between these existing systems and embodiments of the present invention. For example, in one embodiment of the present invention, there is no need for circuitry to offset the projected sub-frames 110 temporally. In one form of the invention, the sub-frames 110 from the component projectors 112 are projected “in-sync”. As another example, unlike some existing systems where all of the sub-frames go through the same optics and the shifts between sub-frames are all simple translational shifts, in one form of the present invention, the sub-frames 110 are projected through the different optics of the multiple individual projectors 112. In one form of the invention, the signal processing model that is used to generate optimal sub-frames 110 takes into account relative geometric distortion among the component sub-frames 110, and is robust to minor calibration errors and noise.

It can be difficult to accurately align projectors into a desired configuration. In one embodiment of the invention, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods assume simple shift offsets between projectors, use frequency domain analyses, and rely on heuristic methods to compute component sub-frames. In contrast, one form of the present invention utilizes an optimal real-time sub-frame generation algorithm that explicitly accounts for arbitrary relative geometric distortion (not limited to homographies) between the component projectors 112, including distortions that occur due to a target surface 116 that is non-planar or has surface non-uniformities. One form of the present invention generates sub-frames 110 based on a geometric relationship between a hypothetical high-resolution reference projector 118 at any arbitrary location and each of the actual low-resolution projectors 112, which may also be positioned at any arbitrary location.

One form of the present invention provides a system 100 with multiple overlapped low-resolution projectors 112, with each projector 112 projecting a different colorant to compose a full color high-resolution image 114 on the screen 116 with minimal color artifacts due to the overlapped projection. By imposing a color-prior model via a Bayesian approach as is done in one embodiment of the invention, the generated solution for determining sub-frame values minimizes color aliasing artifacts and is robust to small modeling errors.

Using multiple off the shelf projectors 112 in system 100 allows for high resolution. However, if the projectors 112 include a color wheel, which is common in existing projectors, the system 100 may suffer from light loss, sequential color artifacts, poor color fidelity, reduced bit-depth, and a significant tradeoff in bit depth to add new colors. One form of the present invention eliminates the need for a color wheel, and uses in its place, a different color filter for each projector 112. Thus, in one embodiment, projectors 112 each project different single-color images. By not using a color wheel, segment loss at the color wheel is eliminated, which could be up to a 20% loss in efficiency in single chip projectors. One embodiment of the invention increases perceived resolution, eliminates sequential color artifacts, improves color fidelity since no spatial or temporal dither is required, provides a high bit-depth per color, and allows for high-fidelity color.

Image display system 100 is also very efficient from a processing perspective since, in one embodiment, each projector 112 only processes one color plane. Thus, each projector 112 reads and renders only one-third (for RGB) of the full color data.

In one embodiment, image display system 100 is configured to project images 114 that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment of the present invention, a first plurality of the projectors 112 may be used to produce any desired brightness for the first image (e.g., left eye image), and a second plurality of the projectors 112 may be used to produce any desired brightness for the second image (e.g., right eye image). In another embodiment, image display system 100 may be combined or used with other display systems or display techniques, such as tiled displays.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of displaying images with a display system, the method comprising:
receiving image data for the images;
generating a plurality of multiple-color frames corresponding to the image data;
generating a first single-color frame based on the plurality of multiple-color frames;
processing the first single-color frame, thereby generating a first processed single-color sub-frame;
generating a first plurality of single-color sub-frames based on the first processed single-color sub-frame; and
projecting the first plurality of single-color sub-frames onto a target surface with a first projector.

2. The method of claim 1, wherein each multiple-color frame includes a plurality of color fields, each color field corresponding to a different color.

3. The method of claim 2, further comprising:
combining a first one of the color fields from each of the multiple-color frames to generate the first single-color frame.

4. The method of claim 3, further comprising:
combining a second one of the color fields from each of the multiple-color frames to generate a second single-color frame;
processing the second single-color frame, thereby generating a second processed single-color sub-frame;
generating a second plurality of single-color sub-frames based on the second processed single-color sub-frame; and
projecting the second plurality of single-color sub-frames onto the target surface with a second projector.

5. The method of claim 4, wherein the sub-frames projected by the second projector at least partially overlap the sub-frames projected by the first projector.

6. The method of claim 4, wherein the single-color of the first plurality of sub-frames is different than the single-color of the second plurality of sub-frames.

7. The method of claim 1, wherein the first processed single-color sub-frame is generated based on maximization of a probability that a simulated image is the same as the image data.

8. The method of claim 7, wherein the simulated image is defined as a summation of up-sampled, filtered, and geometrically transformed sub-frames.

9. The method of claim 8, wherein the geometric transformation of the sub-frames is represented by an operator that geometrically transforms the sub-frames based on relative positions of projectors in the display system with respect to a hypothetical reference projector.

10. The method of claim 1, wherein the processing of the first single-color frame is performed by a graphical processing unit (GPU).

11. A system for displaying images based on received image data, the system comprising:
a frame generator configured to generate a plurality of multiple-color frames corresponding to the received image data;
a processor configured to generate a first single-color frame based on the plurality of multiple-color frames;
a processing unit configured to process the first single-color frame, thereby generating single-color sub-frame data for a first plurality of single-color sub-frames; and
a first projector configured to project the first plurality of single-color sub-frames onto a target surface.

12. The system of claim 11, wherein each of the multiple-color frames includes a plurality of color fields corresponding to different colors.

13. The system of claim 12, wherein the processor is configured to generate the first single-color frame by combining a first one of the color fields from each of the multiple-color frames.

14. The system of claim 13, further comprising:
a memory adapted to store the generated plurality of multiple-color frames.

15. The system of claim 13, wherein the processor is configured to combine a second one of the color fields from each of the multiple-color frames to form a second single-color sub-frame.

16. The system of claim 15, wherein the single-color of the first single-color sub-frame is different than the single-color of the second single-color sub-frame.

17. The system of claim 11, wherein the processing unit geometrically transforms the first single-color frame.

18. The system of claim 17, wherein the geometric transformation is based on a position of the first projector with respect to a hypothetical reference projector.

19. The system of claim 11, wherein the processing unit is a graphical processing unit (GPU).

20. The system of claim 11, wherein the processing unit is a field programmable gate array (FPGA).

21. The system of claim 11, wherein the processing unit is an application specific integrated circuit (ASIC).

22. A system for generating sub-frames for projection onto a viewing surface, the system comprising:
means for receiving image data;
means for generating a plurality of multiple-color frames corresponding to the image data, each of the multiple-color frames including a plurality of color fields corresponding to different colors;
means for combining a first one of the color fields from each of the multiple-color frames to form a first single-color frame; and
means for processing the first single-color frame, thereby generating processed single-color sub-frame data for a first plurality of single-color sub-frames.

23. The system of claim 22, further comprising:
means for combining a second one of the color fields from each of the multiple-color frames to form a second single-color frame.

24. The system of claim 23, further comprising:
means for processing the second single-color frame, thereby generating processed single-color sub-frame data for a second plurality of single-color sub-frames.

25. The system of claim 22, wherein the means for processing geometrically transforms the first single-color frame.

26. The system of claim 25, wherein the geometric transformation is based on a position of a projector with respect to a hypothetical reference projector.

27. A computer-readable medium having computer-executable instructions for performing a method-of generating low-resolution sub-frames for projection onto a viewing surface, the method comprising:
receiving image data;
generating a plurality of multiple-color frames corresponding to the image data, each of the multiple-color frames including a plurality of color fields, each color field corresponding to a different color;
combining a first one of the color fields from each of the multiple-color frames to form a first single-color frame;
processing the first single-color frame with a graphical processing unit, thereby generating a first set of processed single-color sub-frame data; and
generating a first plurality of single-color sub-frames based on the first set of processed single-color sub-frame data.

28. The computer-readable medium of claim 27, wherein the method further comprises:
combining a second one of the color fields from each of the multiple-color frames to form a second single-color frame;
processing the second single-color frame with the graphical processing unit, thereby generating a second set of processed single-color sub-frame data; and
generating a second plurality of single-color sub-frames based on the second set of processed single-color sub-frame data.

29. The computer-readable medium 27, wherein the first set of processed single-color sub-frame data is generated based on maximization of a probability that a stimulated image is the same as the image data.
